(19) United States
(12) Patent Application Publication
(10) Pub. No.: US 2024/0230464 A1
(43) Pub. Date: Jul. 11, 2024

(54) OPTICAL MONITOR DEVICE

(71) Applicant: NIPPON TELEGRAPH AND TELEPHONE CORPORATION, Tokyo (JP)

(72) Inventors: Ryo KOYAMA, Musashino-shi, Tokyo (JP); Yoshiteru ABE, Musashino-shi, Tokyo (JP); Kazunori KATAYAMA, Musashino-shi, Tokyo (JP)

(73) Assignees: NIPPON TELEGRAPH AND TELEPHONE CORPORATION, Tokyo (JP); NIPPON TELEGRAPH AND TELEPHONE CORPORATION, Tokyo (JP)

(21) Appl. No.: 18/288,988

(22) PCT Filed: May 28, 2021
(86) PCT No.: PCT/JP2021/020450

§ 371 Date: Oct. 30, 2023

(51) Int. Cl. G01M 11/00; G01M 11/02

(52) U.S. Cl. CPC G01M 11/37; G01M 11/0207

(57) ABSTRACT

The present disclosure aims to reduce the size and cost of this optical monitoring device that detects the intensity of light propagating through an optical fiber.

The present disclosure relates to an optical monitoring device for detecting the intensity of light propagating through an optical fiber, the optical monitoring device comprising an optical component that branches part of incident light in a first direction and branches the rest in a second direction at a specific branching ratio and emits the light, wherein the optical component includes: a single-layer film having a uniform thickness; an incident-side member provided on the incident side of the single-layer film; and an outgoing-side member provided on the outgoing side of the single-layer film, a first refractive index interface between the single-layer film and the incident-side member and a second refractive index interface between the single-layer film and the outgoing-side member are provided at a specific angle with an optical axis of the incident light, the first direction is a direction in which the light transmits through the first refractive index interface and the second refractive index interface, and the second direction is a direction in which the light is reflected on the first refractive index interface and the second refractive index interface.

### TECHNICAL FIELD

The present disclosure relates to an optical monitoring device, and more particularly to an optical monitoring device for detecting the intensity of light and feeding back the detection result to other components in an optical transmission device or the like.

### BACKGROUND ART

In recent years, with the increase in Internet traffic, there is a strong demand for increased communication capacity in communication systems. In order to achieve this, a communication system using an optical fiber is used in an access network between a communication station and a user home, and in a core network connecting communication stations. In optical fiber communication, detection of the intensity of light propagating through an optical fiber is often performed to control communication and confirm the soundness of the equipment. For example, in an access network, test light is propagated through an optical fiber, and loss and soundness of the optical fiber and an object and a connection of a core wire are confirmed from the detection of the light intensity of the test light. Further, in WDM (Wavelength Division Multiplexing) transmission used in a core network, it is necessary to monitor light intensity for feedback control.

For monitoring the light intensity of an access network, for example, the technique described in PTL 1 is used. PTL 1 describes a technique for branching light at a constant branching ratio by two parallel waveguides, wherein the intensity and propagation loss of an optical signal in an access network can be measured.

For monitoring the light intensity in WMD transmission, for example, the technique disclosed in PTL 2 is used. PTL 2 discloses a technique for simultaneously monitoring the intensities of optical signals of a plurality of optical fibers by a combination of one-dimensionally arranged optical fibers and a dielectric multilayer film.

However, the optical monitoring device having the conventional arrangement has the following problems.

While optical communication is widely used and the number of optical fiber cores of optical equipment/cable is increased, first, in the case of an optical monitoring device using an optical coupler for each optical fiber core, the cost and the size are increased in accordance with the increase in the number of optical fiber cores. In the case of an optical monitoring device in which optical fibers and optical intensity sensors are arranged in a one-dimensional array, there is a limit in the arrangement of the optical fibers, and if the number of cores of the optical fibers exceeds it, the cost and size are increased according to the number of cores.

As a spatial optical system for constituting such an optical monitoring device, for example, in PTL 2, a dielectric multilayer film is used for optical branching. However, since the dielectric multilayer film generally has a high light reflectance, the loss of the signal transmitted through the optical monitoring device is increased. Further, since the dielectric multilayer film generally reflects only a specific wavelength band, it is not suitable for monitoring communication using a wide wavelength band such as WDM transmission.

### CITATION LIST

### Patent Literature

[PTL 1] Japanese Patent Application No. 3450104 (Furukawa Electric Co., Ltd.)
[PTL 2] Japanese Patent Application Publication No. 2004-219523 (Fujitsu, withdrawn)

### SUMMARY OF INVENTION

### Technical Problem

The present disclosure aims to monitor optical signals in a wide wavelength range in an optical monitoring device for a multi-core optical fiber.

### Solution to Problem

In order to achieve the object described above, an optical monitoring device according to the present disclosure is an optical monitoring device for detecting the intensity of light propagating through a plurality of optical fibers, the optical monitoring device comprising:
an optical component that branches part of incident light in a first direction and branches the rest in a second direction at a specific branching ratio and emits the light,
wherein the optical component includes:
a single-layer film having a uniform thickness;
an incident-side member provided on an incident side of the single-layer film and having a refractive index different from that of the single-layer film; and
an outgoing-side member provided on an outgoing side of the single-layer film and having the same refractive index as that of the incident-side member,
a first refractive index interface between the single-layer film and the incident-side member and a second refractive index interface between the single-layer film and the outgoing-side member are provided at a specific angle with an optical axis of the incident light, the first direction is a direction in which the light transmits through the first refractive index interface and the second refractive index interface, and
the second direction is a direction in which the light is reflected on the first refractive index interface and the second refractive index interface.

### Advantageous Effects of Invention

The optical monitoring device of the present disclosure is an optical monitoring device that detects the intensity of light propagating through a plurality of optical fibers and branches incident light using a single-layer film having a uniform thickness. Since the optical monitoring device of the present disclosure branches incident light using a single-layer film, an optical signal in a wide wavelength range can be monitored. Therefore, according to the present disclosure, an optical signal in a wide wavelength range can be monitored in an optical monitoring device for a multi-core optical fiber.

### BRIEF DESCRIPTION OF DRAWINGS

FIG. 1 shows an embodiment of an optical monitoring device according to the present disclosure.

FIG. 2 shows an example of light propagating through a spatial optical system.

FIG. 3 shows an embodiment of the optical monitoring device according to the present disclosure.

FIG. 4 shows an example of an optical path in a single-layer film.

FIG. 5 shows an example of a branching ratio in a spatial optical system.

FIG. 6 shows an example of the relationship between the minimum branching ratio and the ratio of the thickness of the single-layer film and the luminous flux radius.

### DESCRIPTION OF EMBODIMENTS

Embodiments of the present disclosure will be described hereinafter in detail with reference to the drawings. It is to be understood that the present disclosure is not limited to the embodiments described below. The embodiments are merely exemplary and the present disclosure can be implemented in various modified and improved modes based on knowledge of those skilled in the art. Constituent elements with the same reference signs in the present specification and in the drawings represent the same constituent elements.

### First Embodiment

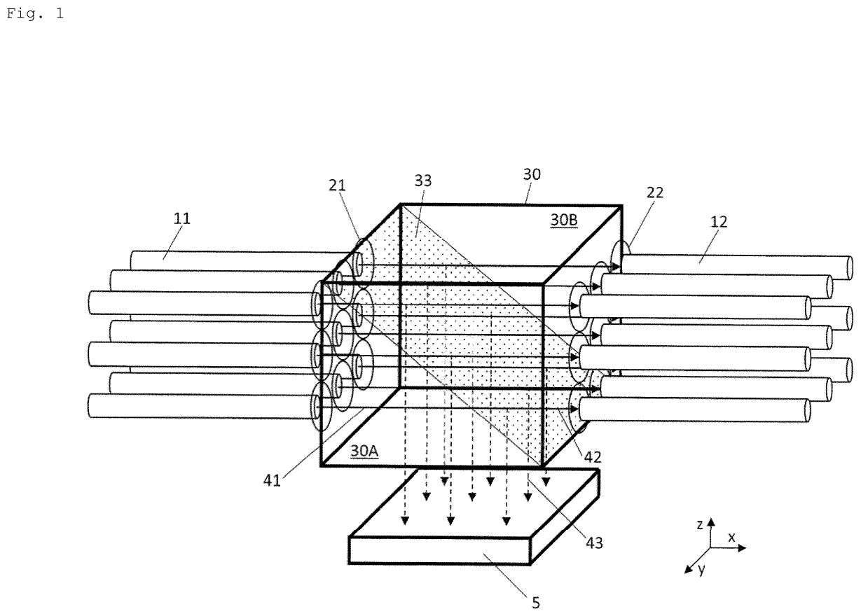

An optical monitoring device according to the present embodiment has a configuration illustrated in FIG. 1.

The optical monitoring device according to the present embodiment is an optical monitoring device for detecting the intensity of light propagating through a plurality of incident-side optical fibers 11, the optical monitoring device including:
a spatial optical system 30 that, for incident light from the incident-side optical fibers 11, branches most of incident light 41 into a specific first direction and the rest into another specific second direction at a constant branching ratio, and emits each branched light beam;
the incident-side optical fiber 11 that is arranged in a two-dimensional array so as to make light incident on the spatial optical system 30 and propagates a plurality of light beams;
an outgoing-side optical fiber 12 that is arranged so as to receive most of outgoing light 42 emitted from the spatial optical system 30 in the first direction and propagates a plurality of light beams;
a light-receiving unit 5 that is arranged so as to receive part of the outgoing light 43 emitted from the spatial optical system 30 in the second direction;
an incident-side optical lens 21 that is arranged between the spatial optical system 30 and the incident-side optical fibers 11 and makes the respective incident light beams from the incident-side optical fibers 11 to the spatial optical system 30 into parallel light; and
an outgoing-side optical lens 22 that is arranged between the spatial optical system 30 and the outgoing-side optical fiber 12 and efficiently couples each outgoing light beam from the spatial optical system 30 to the outgoing-side optical fiber 12 corresponding to the incident-side optical fiber 11.

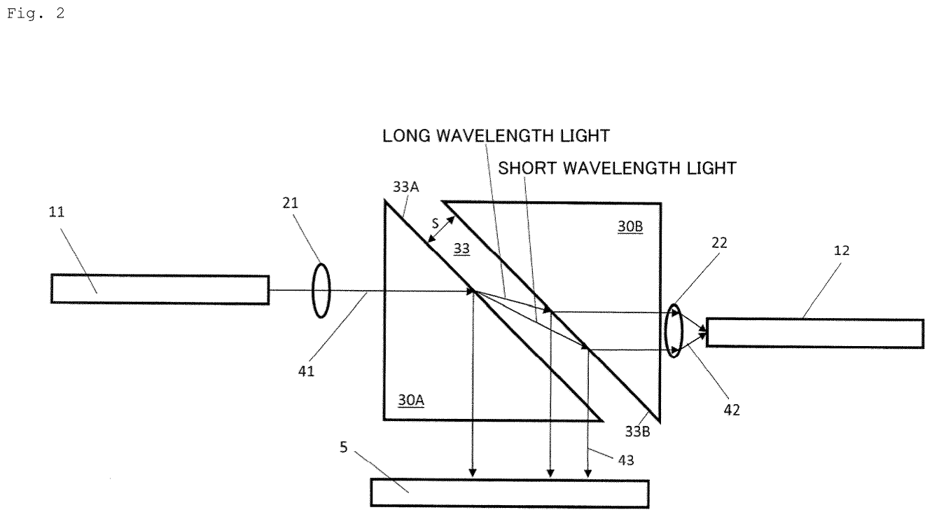

In addition, in the optical monitoring device of the present embodiment, as illustrated in FIG. 2, the spatial optical system 30 includes a single-layer film 33 that has another uniform refractive index provided between an incident-side member 30A and an outgoing-side member 30B composed of a material having a uniform refractive index, the single-layer film 33 being provided at a specific angle (45 degrees in the diagram) with respect to the optical axis of the incident light 41. Therefore, a first refractive index interface 33A between the single-layer film 33 and the incident-side member 30A and a second refractive index interface 33B between the single-layer film 33 and the outgoing-side member 30B are respectively provided at a specific angle with the optical axis of incident light.

Although FIG. 1 shows an example in which the specific angle is 45 degrees and the direction of the reflected light is 90 degrees, the direction of the reflected light is not fixed to 90 degrees but can be changed as necessary. Also, the spatial optical system 30 is not limited to a spatial system, but any optical component having a branching surface capable of branching into two light beams with different directions can be used.

According to the optical monitoring device shown in FIGS. 1 and 2, since the incident light 41 from the incident-side optical fiber 11 becomes parallel light at the incident-side optical lens 21, loss due to diffusion can be prevented. Furthermore, most of the outgoing light 42 is guided to the outgoing-side optical lens 22 by the spatial optical system 30. The outgoing-side optical lens 22 condenses the light passing through the spatial optical system 30 and couples the light to the outgoing-side optical fiber 12. In this manner, most of the outgoing light 42 emitted from the incident-side optical fiber 11 can be guided to the outgoing-side optical fiber 12 in a state where the loss is small.

On the other hand, part of the outgoing light 43 branched by the spatial optical system 30 is guided to the light-receiving unit 5 arranged in a direction different from that of the most of the outgoing light 42. Thus, the optical monitoring device of the present embodiment can measure the intensity of part of the light propagating from the incident-side optical fiber 11 to the outgoing-side optical fiber 12. If the branching ratio of the outgoing light 42 and the outgoing light 43 in the spatial optical system 30 is known in advance. When, for example, N:1 and the intensity of the light measured by the light-receiving unit 5 is L (the unit is mW, for example), the intensity of the light incident from the incident-side optical fiber 11 is (N+1)×L, and the intensity of the light propagated to the outgoing-side optical fiber 12 can be known as N×L.

The light-receiving unit 5 may be constituted of a plurality of light-receiving elements arranged so as to match the two-dimensional array shape of the incident-side optical fiber 11, or may be constituted of one light-receiving element capable of detecting light intensity for each incident position from each incident-side optical fiber 11 such as an area image sensor. In this case, the intensity of each outgoing light beam 43 detected by the light-receiving unit 5 is output for each incident-side optical fiber 11. Thus, the number of components can be reduced, and the incident-side optical fiber 11 of an arbitrary two-dimensional array can be applied.

According to the optical monitoring device illustrated in FIGS. 1 and 2, incident light is branched by Fresnel reflection at the refractive index interfaces 33A and 33B. Since Fresnel reflection does not depend on a wavelength and depends on the refractive index at the refractive index interfaces 33A and 33B, light is branched in a wide wavelength region.

FIG. 2 illustrates a difference in optical paths depending on the wavelength of incident light when the incident-side member 30A and the outgoing-side member 30B have the same refractive index. When the incident-side member 30A and the outgoing-side member 30B have the same refractive index, the single-layer film 33 advances in a different direction when the wavelengths differ. Therefore, the incident position with respect to the refractive index interface 33B differs depending on the wavelength. On the other hand, the light incident from the refractive index interface 33B advances in the same direction as the incident-side member 30A by refraction between the single-layer film 33 and the outgoing-side member 30B. Therefore, even if the optical axes at the incident end faces of the respective outgoing-side optical fibers 12 are arranged in parallel, the transmitted light can be coupled to the outgoing-side optical fibers 12 regardless of the wavelength.

In this manner, in the present disclosure, a difference in the position of incidence on the refractive index interface 33B depending on wavelength occurs in the single-layer film 33. Therefore, in the present disclosure, the position of the outgoing-side optical lens 22 is determined according to the center wavelength of the incident light 41, the refraction angle, and the thickness S of the single-layer film 33.

The width of the light reaching the outgoing-side optical lens 22 mainly depends on the wavelength width of the incident light 41 and the thickness S of the single-layer film 33. When the width of the light reaching the outgoing-side optical lens 22 is smaller than the diameter of the outgoing-side optical lens 22, the optical loss is small, and when the width is larger, the optical loss is large. Therefore, by setting the diameter of the outgoing-side optical lens 22 to a value determined according to the wavelength width of the incident light 41 and the thickness S of the single-layer film 33 or more, the optical loss can be reduced. On the other hand, when the diameter of the outgoing-side optical lens 22 becomes equal to or larger than the installation interval of the incident-side fiber, the outgoing-side optical lens 22 collides with the adjacent lens, so the diameter of the outgoing-side optical lens 22 needs to be less than or equal to the installation interval of the incident-side fiber.

### Effect of the Present Disclosure

According to the optical monitoring device shown in FIG. 1, the incident-side optical fiber 11 and the outgoing-side optical fiber 12 are two-dimensionally arranged, and the two-dimensionally arranged luminous flux is branched by the spatial optical system 30. Thus, it is possible to reduce the size of the optical monitoring device for each single-core optical fiber or the optical monitoring device in which the optical fibers are arranged one-dimensionally. Further, since the number of components is small, the cost can be easily reduced. In addition, since light is branched in a wide wavelength region, an optical signal in a wider wavelength region than an optical monitoring device using a dielectric multilayer film can be monitored. Therefore, the optical monitoring device of the present disclosure can monitor an optical signal in a wide wavelength range, and can realize a compact and low-cost optical monitoring device for an optical fiber having a large number of cores such as several tens of cores.

Although FIG. 1 shows an example in which the incident-side optical fiber 11, the outgoing-side optical fiber 12, the incident-side optical lens 21, and the outgoing-side optical lens 22 are arranged in a two-dimensional array of 3×3, a combination of an arbitrary number of 2×2 or more can be adopted.

### Second Embodiment

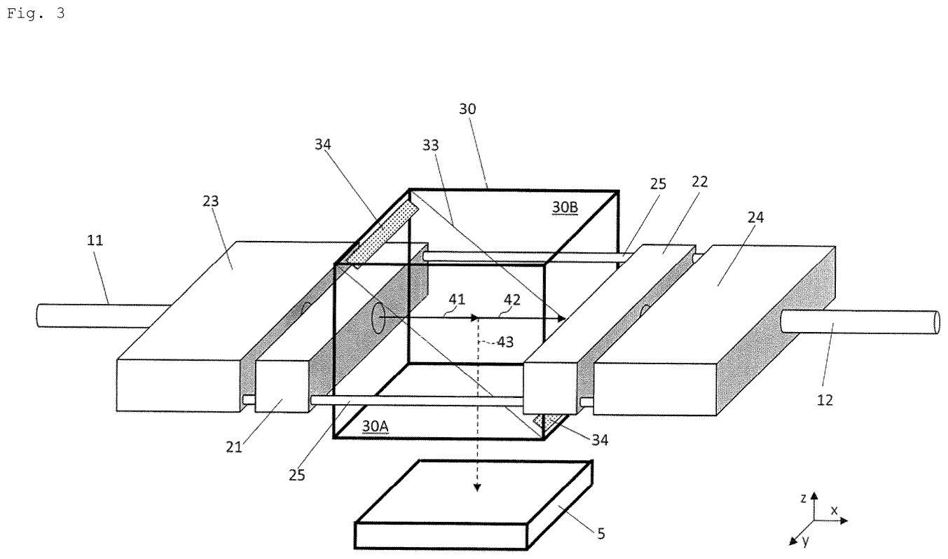

FIG. 3 shows an example of the configuration of the optical monitoring device according to the present embodiment. The incident-side member 30A and the outgoing-side member 30B can be made of a transparent material such as quartz glass. The single-layer film 33 can utilize an air layer by arranging a spacer 34 of a predetermined thickness between the incident-side member 30A and the outgoing-side member 30B and providing a gap. The incident-side optical lens 21 and the outgoing-side optical lens 22 can be realized with a collimator that incorporates a GRIN (GRaded INdex) fiber in a rectangular ferrule used in optical connectors and the like. The incident-side optical fiber 11 and the outgoing-side optical fiber 12 are also built in rectangular ferrules 23 and 24 similarly to the incident-side optical lens 21 and the outgoing-side optical lens 22, and the optical axes of the incident-side optical fiber 11, the incident-side optical lens 21, the outgoing-side optical fiber 12, and the outgoing-side optical lens 22 can be aligned by using a guide pin 25 and a guide hole as with optical connectors. The light-receiving unit 5 can be realized by a commercially available optical image sensor. Unnecessary Fresnel reflection can be suppressed by filling the connection part other than the single-layer film 33 with refractive index matching material.

In order to suppress unnecessary Fresnel reflection, it is desirable that the refractive indexes of the incident-side member 30A and the outgoing-side member 30B are equal to those of the optical fiber cores of the incident-side optical fiber 11 and the outgoing-side optical fiber 12. For example, in the case where the incident-side optical fiber 11 and the outgoing-side optical fiber 12 are quartz glass fiber cores used for communication optical fibers, it is preferable to use a refractive index matching material having a refractive index of 1.47. It can be said that an air layer (refractive index 1) is used for the single-layer film 33 as an inexpensive structure. When the angle of incidence on the single-layer film 33 is set to 30 degrees, Fresnel reflectance (p-polarized light) is 8.5%.

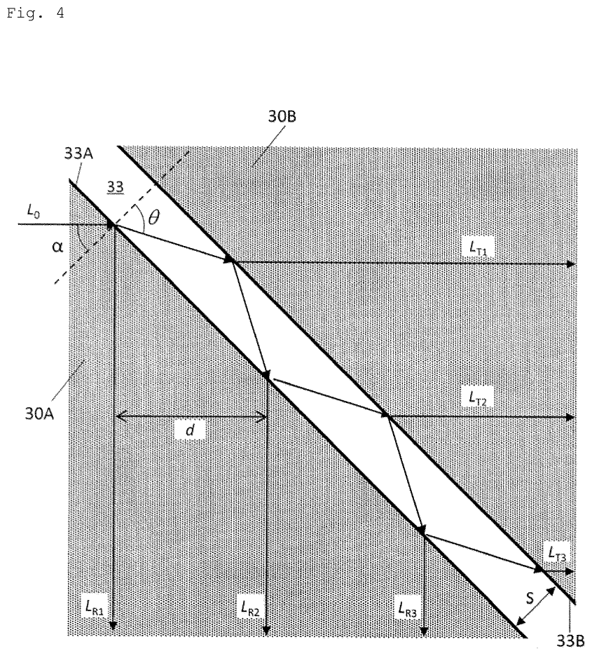

FIG. 4 illustrates the detailed states of transmitted light and reflected light in the single-layer film 33. When the intensity of the incident light 41 incident on the spatial optical system 30 from the incident-side optical fiber 11 is taken as L₀, the intensities L_{R1}, L_{R2}, and L_{R3} of the primary reflected light, the secondary reflected light, and the tertiary reflected light are respectively expressed by the following expressions.

$${L}_{R 1} = {r}_{1} {L}_{0} \qquad ( Expression 1 )$$

$${L}_{R 2} = ( 1 - {r}_{1} ) ( 1 - {r}_{2} ) {r}_{2} {L}_{0} {e}^{- i δ} \qquad ( Expression 2 )$$

$${L}_{R 3} = ( 1 - {r}_{1} ) ( 1 - {r}_{2} ) {r}_{2}^{3} {L}_{0} {e}^{- i 2 δ} \qquad ( Expression 3 )$$

Here, r₁ is a Fresnel reflectance at the refractive index interface 33A, and r₂ is a Fresnel reflectance at the refractive index interface 33B. In addition, δ is the phase of light traveling in the single-layer film 33, and 4πnS cos θ/λ. Here, n is the refractive index of the single-layer film 33, S is the thickness of the single-layer film 33, θ is the refractive angle, and Δ is the wavelength of light. In the present embodiment, since the single-layer film 33 is an air layer, the refractive index n is 1. Also, FIG. 4 shows intensities L_{T1}, LT₂, and LT₃ of primary transmission light, secondary transmission light, and tertiary transmission light, respectively.

If the incident light 41 becomes a parallel flux of a luminous flux radius R in the incident-side optical lens 21, the overlapping integral of the i-th order reflected light and the j-th order reflected light is expressed by the following expression.

$${k}_{ij} = exp ( - \frac{{( i - j )}^{2} {d}^{2}}{R} ) \qquad ( Expression 4 )$$

Here, d=2S tan θ cos α, and α is an incident angle. Thus, Expression 4 is expressed by the following expression.

$${k}_{ij} = exp ( - 4 {( i - j )}^{2} {tan}^{2} θ {cos}^{2} α \frac{{S}^{2}}{{R}^{2}} ) \qquad ( Expression 5 )$$

If reflected light of 4th order or higher is minimal and therefore ignored, the intensity L of the light reflected by the spatial optical system 30 and received by the light-receiving unit 5 is expressed by the following expression.

$$L = \vert {k}_{11} {L}_{1} + {k}_{12} {L}_{2} + {k}_{13} {L}_{3} \vert + \vert ( 1 - {k}_{12} ) ( {k}_{22} {L}_{2} + {k}_{23} {L}_{3} ) \vert + \vert ( 1 - {k}_{13} ) ( 1 - {k}_{23} ) ( {k}_{33} {L}_{3} ) \vert \qquad ( Expression 6 )$$

Here, kᵢᵢ=1 is satisfied.

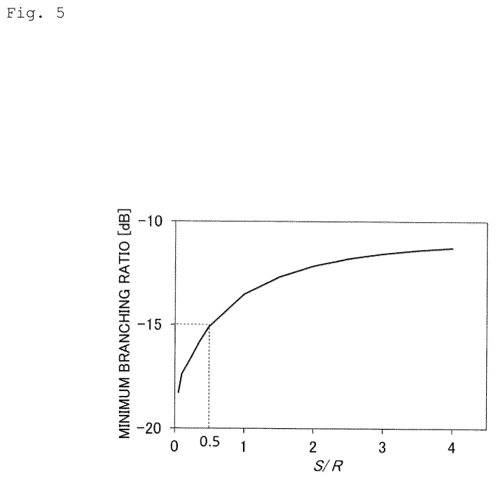

FIG. 5 shows the relationship between the minimum branching ratio and the ratio of the thickness S of the single-layer film 33 to the luminous flux radius R. The minimum optical signal intensity of an optical communication device is internationally standardized in IEC 61753-1, for example, and is approximately −20 to −25 dB. On the other hand, since the minimum photosensitivity of the optical sensor is generally −40 dB, a branching ratio of −15 dB or more is required to be usable in a wide range of devices. It can be seen from FIG. 5 that the thickness S of the single-layer film 33 having S/R of 0.5 or more is required.

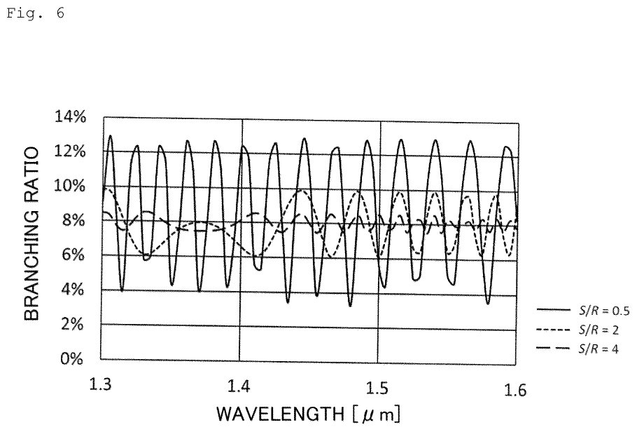

FIG. 6 shows the branching ratio in the spatial optical system 30 obtained when the ratio of the thickness S of the single-layer film 33 to the luminous flux radius R is changed. It can be seen that light can be branched in a wide wavelength band in any of the cases of S/R=0.5, 2.0, and 4.0. However, when the ratio of S to R is 0.5, a wavelength band having a small branching ratio appears due to interference in the spatial optical system 30. Accordingly, interference occurs in the spatial optical system 30 depending on the combination of the thickness S of the single-layer film 33 and the luminous flux radius R. Therefore, it is preferable to set the luminous flux radius R having the thickness S of the single-layer film 33 in which the ratio of S to R is 0.5 or more and avoiding interference in the single-layer film 33.

Although the embodiments have been described above, the present invention is not limited thereto. For example, although the present disclosure has described an example in which the single-layer film 33 is an air layer, the single-layer film 33 may be glass having a refractive index lower than those of the incident-side member 30A and the outgoing-side member 30B. The spatial optical system 30 is not limited to having a cubic shape, but may have any shape such as a rectangular parallelepiped. Also, the light-receiving unit 5 can be arranged at any position where the light branched by the spatial optical system 30 can be received. For example, the light-receiving unit 5 may be embedded in the spatial optical system 30.

The optical monitoring device of the present disclosure can also be used for monitoring any light transmitted in an optical transmission system. For example, the optical monitoring device of the present disclosure can be mounted on any device used in an optical transmission system such as a transmitter, a receiver, or a relay device, and the measurement result in the light-receiving unit 5 can be used for feedback or feed-forward to any component inside or outside the device. Furthermore, the optical monitoring device of the present disclosure can be inserted in the middle of a transmission line in an optical transmission system, and the intensity and propagation loss of an optical signal in the transmission line can be measured.

### INDUSTRIAL APPLICABILITY

The present disclosure is applicable to information and communication industries.

### REFERENCE SIGNS LIST

5: Light-receiving unit
11: Incident-side optical fiber
12: Outgoing-side optical fiber
21: Incident-side optical lens
22: Outgoing-side optical lens
23, 24: Ferrule
25: Guide pin
30: Spatial optical system
30A: Incident-side member
30B: Outgoing-side member
33: Single-layer film
34: Spacer
41: Incident light
42: Most of outgoing light
43: Part of outgoing light

1. An optical monitoring device for detecting the intensity of light propagating through a plurality of optical fibers, the optical monitoring device comprising:
an optical component that branches part of incident light in a first direction and branches the rest in a second direction at a specific branching ratio and emits the light,
wherein the optical component includes:
a single-layer film having a uniform thickness;
an incident-side member provided on an incident side of the single-layer film and having a refractive index different from that of the single-layer film; and
an outgoing-side member provided on an outgoing side of the single-layer film and having the same refractive index as that of the incident-side member,
a first refractive index interface between the single-layer film and the incident-side member and a second refractive index interface between the single-layer film and the outgoing-side member are provided at a specific angle with an optical axis of the incident light,
the first direction is a direction in which the light transmits through the first refractive index interface and the second refractive index interface, and
the second direction is a direction in which the light is reflected on the first refractive index interface and the second refractive index interface.

2. The optical monitoring device according to claim 1, wherein the incident-side member and the outgoing-side member have the same refractive index.

3. The optical monitoring device according to claim 1, wherein the single-layer film is an air layer.

4. The optical monitoring device according to claim 1, further comprising: a plurality of incident-side optical fibers arranged in a two-dimensional array so as to make light incident on the optical component;
a plurality of outgoing-side optical fibers arranged in a two-dimensional array so as to receive each outgoing light beam from the optical component in the first direction;
a light-receiving unit arranged so as to receive each outgoing light beam emitted from the optical component in the second direction;
an incident-side optical lens arranged between the optical component and the incident-side optical fibers and configured to make each incident light beam for the optical component into parallel light; and
an outgoing-side optical lens arranged between the optical component and the outgoing-side optical fibers and coupling each outgoing light beam from the optical component to the outgoing-side optical fibers.

5. The optical monitoring device according to claim 4 wherein the single-layer film has a thickness S so that a ratio of the thickness S of the single-layer film to a luminous flux radius R of parallel light emitted from the incident-side optical lens is 0.5 or more, the light flux radius being able to avoid interference in the single-layer film.

6. The optical monitoring device according to claim 4, wherein the position of the outgoing-side optical lens is determined according to a center wavelength of each incident light beam.

7. The optical monitoring device according to claim 4, wherein a diameter of the outgoing-side optical lens is equal to or greater than a value determined according to a wavelength width of each incident light beam, and is equal to or less than an installation interval of the incident-side optical fibers.
